(19) United States
(12) Patent Application Publication
(10) Pub. No.: US 2026/0000067 A1
(43) Pub. Date: Jan. 1, 2026

(54) MOUSE REPELLING DEVICE AND METHOD FOR REPELLING MOUSE

(71) Applicant: Logicarer Biotechnology (Shenzhen) Co., Ltd., Shenzhen (CN)

(72) Inventor: Zhen XIE, Shenzhen (CN)

(73) Assignee: Logicarer Biotechnology (Shenzhen) Co., Ltd., Shenzhen (CN)

(21) Appl. No.: 18/809,707

(22) Filed: Aug. 20, 2024

(30) Foreign Application Priority Data
Jun. 26, 2024 (CN) 202410847134.0

(51) Int. Cl. A01M 29/18; A01M 29/10

(52) U.S. Cl. CPC A01M 29/18; A01M 29/10

(57) ABSTRACT

Disclosed are a mouse repelling device and a method for repelling the mouse. The mouse repelling device includes a main control board, a repelling module, a camera, a real-time clock module and a temperature and humidity sensor. The mouse repelling module includes a sound simulator and a high-frequency flashlight. Both the sound simulator and the high-frequency flashlight are electrically connected to the main control board. The camera, the real-time clock module and the temperature and humidity sensor are all electrically connected to the main control board.

### CROSS-REFERENCE TO RELATED APPLICATIONS

This application claims priority to Chinese Patent Application No. 202410847134.0, filed on Jun. 26, 2024, the entire contents of which are incorporated herein by reference.

### TECHNICAL FIELD

The present application relates to the technical field of pest controlling, and in particular to a mouse repelling device and a method for repelling a mouse.

### BACKGROUND

A clean and hygienic home environment is what people pursue and yearn for, and it is also an important guarantee for everyone's comfortable and healthy life. However, damp and dark environments such as kitchens and bathrooms are often prone to breeding cockroaches, mosquitoes, mice and other vectors. These creatures not only damage electrical wires, but also steal food, spread germs, and harm people's health. According to statistics from the World Health Organization, one in ten people in the world get sick every year from eating contaminated food.

Flies, mice, cockroaches, and mosquitoes are called “four household pests”. Eliminating the four pests is an important measure to control vector-borne diseases and protect the health of the population, and it is also one of the important tasks of the national health work operation. Among these four pests, mice are the most difficult to avoid and control. Mice often appear in humid environments. For some houses with poor sealing or long-term opened doors, mice can easily enter the room and pose a threat to people's health and safety. Since mice are relatively short and responsive, it is difficult for people to find traces of mice.

In the related art, people usually use mouse repellers to drive away mice. The specific principle is to emit high-frequency sound waves that the frequency is higher than the human hearing range. These sound waves interfere with the auditory system of mice, making them feel uncomfortable and leaving the predetermined area. However, this driving away method is often relatively simple and cannot conduct targeted expulsion under a changeable environment, and the driving away effect is poor.

### SUMMARY

The main purpose of the present application is to provide a mouse repelling device and a method for repelling the mouse, aiming to provide a mouse repelling device that can drive away mice in a targeted and multi-faceted manner according to environmental factors.

In view of above objectives, the mouse repelling device of the present application includes: a main control board; a repelling module including a sound simulator and a high-frequency flashlight, the sound simulator being electrically connected to the main control board, and the high-frequency flashlight being electrically connected to the main control board; a camera electrically connected to the main control board; a real-time clock module electrically connected to the main control board; and a temperature and humidity sensor electrically connected to the main control board.

In an embodiment, the mouse repelling device further includes an artificial intelligence (AI) smart chip. The AI chip is electrically connected to the main control board, and is configured to process data of the real-time clock module and data of the temperature and humidity sensor and control the repelling module to operate.

In an embodiment, the repelling module further includes an ultrasonic generator electrically connected to the main control board.

In an embodiment, the mouse repelling device further includes a moving assembly, and the moving assembly is configured to drive the mouse repelling device to move.

The present application further provides a method for repelling a mouse, applied to the mouse repelling device to repel the mouse, including: acquiring, by the real-time clock module, current time information, and acquiring, by the temperature and humidity sensor, environment temperature and humidity information in a predetermined environment; determining preset operating frequencies of the sound simulator and the high-frequency flashlight according to the current time information and the environment temperature and humidity information; and controlling the sound simulator to emit miaow or a human voice and the high-frequency flashlight to flash according to the preset operating frequencies.

In an embodiment, the determining preset operating frequencies of the sound simulator and the high-frequency flashlight according to the current time information and the environment temperature and humidity information includes: in response to that the current time information is a preset night time, controlling the sound simulator and the high-frequency flashlight to operate at a high frequency; and in response to that the current time information is a preset day time, controlling the sound simulator and the high-frequency flashlight to operate at a low frequency.

In an embodiment, the determining the preset operating frequencies of the sound simulator and the high-frequency flashlight according to the current time information and the environment temperature and humidity information further includes: in response to that the predetermined environment is a high temperature environment or a high humidity environment, controlling the sound simulator and the high-frequency flashlight to operate at the high frequency.

In an embodiment, the method further includes: recognizing, by a camera, that a mouse enters a predetermined space; starting the sound simulator to make miaow or a human voice to frighten the mouse; and starting the high-frequency flashlight to flash along an activity trajectory.

In an embodiment, the obtaining the activity trajectory of the mouse in the predetermined space through the camera includes: obtaining, by the camera in the predetermined space, image information of all organisms in the predetermined space; inputting obtained image information into a preset convolutional neural network (CNN) model for processing and identifying the image information of the mouse in the image information; and obtaining the activity trajectory of the mouse based on the image information of the mouse.

In an embodiment, after the controlling the sound simulator to emit miaow or the human voice and the high-frequency flashlight to flash according to the preset operating frequency, the method further includes: obtaining, by networking, real-time weather forecast information; and determining preset operating frequencies of the sound simulator and the high-frequency flashlight according to the real-time weather forecast information.

In the technical solution of the present application, a mouse repelling device and a method for repelling the mouse are proposed. The mouse repelling device includes a main control board, a repelling module, a camera, a real-time clock module and a temperature and humidity sensor. The sound simulator, the high-frequency flashlight, the camera, the real-time clock module and the temperature and humidity sensor are all electrically connected to the main control board. The specific operating principle of the mouse repelling device is that the real-time clock module feeds back the current time information to the main control board, and the main control board controls the repelling module to repel the mouse according to the current time information. Since the real-time clock module can still maintain a high time accuracy in the offline state, this can make the repelling module drive away mice in a targeted manner according to time and season. For example, at night, mice appear frequently, so that the repelling module is controlled to increase the repelling frequency. The repelling module includes a sound simulator and a high-frequency flashlight. The sound simulator can drive away mice by simulating sounds such as miaow and human voices. The high-frequency flashlight is used together to achieve multi-means combined repelling, thereby achieving a better repelling effect.

### BRIEF DESCRIPTION OF THE DRAWINGS

To more clearly illustrate technical solutions in the embodiments of the present application or the related art, the following will briefly introduce the drawings that need to be used in the description of the embodiments or the related art. Obviously, the drawings in the following description are only some embodiments of the present application. For those skilled in the art, without creative effort, other drawings can be obtained according to the structures shown in these drawings.

FIG. 1 is a schematic structural diagram of a mouse repelling device according to an embodiment of the present application.

FIG. 2 is a schematic structural diagram of a mouse repelling device according to another embodiment of the present application.

FIG. 3 is a schematic flowchart of a method for repelling the mouse according to an embodiment of the present application.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in detail below with reference to the accompanying drawings. It is obvious that the embodiments described are only some rather than all of the embodiments of the present application. All other embodiments obtained by those skilled in the art based on the embodiments of the present application without creative efforts shall fall within the claimed scope of the present application.

It should be noted that all the directional indications (such as up, down, left, right, front, rear . . . ) in the embodiments of the present application are only used to explain the relative positional relationship, movement, or the like of the components in a certain posture. If the specific posture changes, the directional indication will change accordingly.

Besides, the descriptions associated with, e.g., “first” and “second,” in the present application are merely for descriptive purposes, and cannot be understood as indicating or suggesting relative importance or impliedly indicating the number of the indicated technical feature. Therefore, the feature associated with “first” or “second” can expressly or impliedly include at least one such feature. Further, if “and/or” appears throughout the text, it includes three parallel schemes. Taking “A and/or B” as an example, it includes the scheme A, or the scheme B, or the scheme that the scheme A and the scheme B satisfy at the same time. In addition, the technical solutions of the various embodiments can be combined with each other, but the combinations must be based on the realization of those skilled in the art. When the combination of technical solutions is contradictory or cannot be achieved, it should be considered that such a combination of technical solutions does not exist, nor does it fall within the scope of the present application.

A clean and hygienic home environment is what people pursue and yearn for, and it is also an important guarantee for everyone's comfortable and healthy life. However, damp and dark environments such as kitchens and bathrooms are often prone to breeding cockroaches, mosquitoes, mice and other vectors. These creatures not only damage electrical wires, but also steal food, spread germs, and harm people's health. According to statistics from the World Health Organization, one in ten people in the world get sick every year from eating contaminated food.

Flies, mice, cockroaches, and mosquitoes are called “four household pests”. Eliminating the four pests is an important measure to control vector-borne diseases and protect the health of the population, and it is also one of the important tasks of the national health work operation. Among these four pests, mice are the most difficult to avoid and control. Mice often appear in humid environments. For some houses with poor sealing or long-term opened doors, mice can easily enter the room and pose a threat to people's health and safety. Since mice are relatively short and responsive, it is difficult for people to find traces of mice.

In the related art, people usually use mouse repellers to drive away mice. The specific principle is to emit high-frequency sound waves that the frequency is higher than the human hearing range. These sound waves interfere with the auditory system of mice, making them feel uncomfortable and leaving the predetermined area. However, this driving away method is often relatively simple and cannot conduct targeted expulsion under a changeable environment, and the driving away effect is poor.

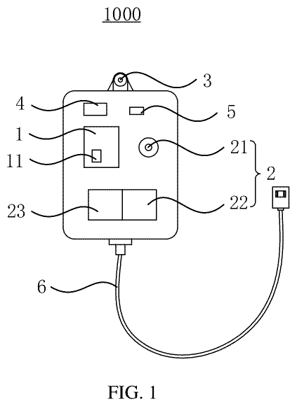

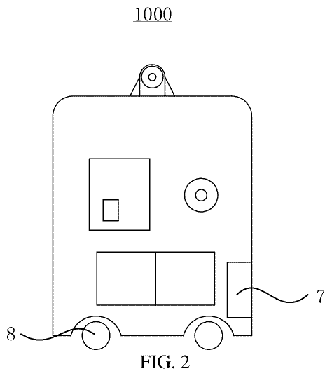

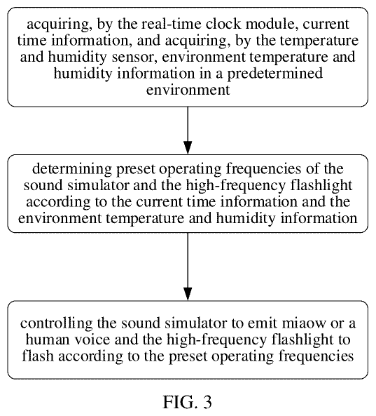

In order to solve the above problems, the present application provides a mouse repelling device and a method for repelling the mouse, aiming to provide a mouse repelling device that can drive away mice in a targeted and multi-faceted manner according to environmental factors. FIG. 1 to FIG. 3 are schematic structural diagrams of the mouse repelling device according to an embodiment of the present application.

As shown in FIG. 1 to FIG. 3, the present application proposes a mouse repelling device 1000 including a main control board 1, a repelling module 2, a camera 3, a real-time clock module 4 and a temperature and humidity sensor 5. The repelling module 2 includes a sound simulator 22 and a high-frequency flashlight 21. The sound simulator 22 and the high-frequency flashlight 21 are electrically connected to the main control board 1. The camera 3, the real-time clock module 4 and the temperature and humidity sensor 5 are also electrically connected to the main control board 1.

In the technical solution of the present application, the operating principle of the real-time clock module 4 is based on a small electronic clock, which is usually provided with a stable pulse signal by a quartz crystal oscillator to ensure the accurate time. The real-time clock module is provided with an independent power supply, such as a button battery, to ensure that accurate time information can be maintained when the main power supply is cut off, so that time tracking can be performed uninterruptedly in an offline state. In the mouse repelling device 1000, the real-time clock module is used to provide current accurate time information, so that the mouse repelling device 1000 can identify the preset night time when the mouse is more active. According to the time information, the main control board 1 of the mouse repelling device 1000 can automatically adjust the operating intensity of the repelling module 2. For example, the frequency and volume of the miaow or ultrasonic sound emitted by the sound simulator 22 will be enhanced at the preset night time, and the flashing frequency of the high-frequency flashlight 21 will also be enhanced, so as to achieve targeted mouse repelling. In this way, the efficiency and adaptability of mouse repelling can be improved, more effective repelling during the most active period of the mouse can be ensured, and the operating intensity during a non-peak period can be reduced to save energy and reduce interference with the environment. It should be noted that the preset night time is from 18:00 to 6:00, and the preset day time is from 6:01 to 17:59. The frequency is gradually increased, which can save energy and ensure effective mouse repellent.

In the technical solution of the present application, a mouse repelling device 1000 and a method for repelling the mouse are proposed. The mouse repelling device 1000 includes a main control board 1, a repelling module 2, a camera 3, a real-time clock module 4 and a temperature and humidity sensor 5. The sound simulator 22, the high-frequency flashlight 21, the camera 3, the real-time clock module 4 and the temperature and humidity sensor 5 are all electrically connected to the main control board 1. The specific operating principle of the mouse repelling device 1000 is that the real-time clock module 4 feeds back the current time information to the main control board 1, and the main control board 1 controls the repelling module 2 to repel the mouse according to the current time information. Since the real-time clock module 4 can still maintain a high time accuracy in the offline state, this can make the repelling module 2 drive away mice in a targeted manner according to time and season. For example, at night, mice appear frequently, so that the repelling module 2 is controlled to increase the repelling frequency. The repelling module 2 includes a sound simulator 22 and a high-frequency flashlight 21. The sound simulator 22 can drive away mice by simulating sounds such as miaow and human voices. The high-frequency flashlight 21 is used together to achieve multi-means combined repelling, thereby achieving a better repelling effect.

In the method for repelling the mouse, a relatively accurate and targeted mouse repelling method is provided. The real-time clock module 4 can not only identify the nighttime period and the daytime period, but also record the current date, which can be divided according to four different seasons as follows: spring usually starting from March 20 or 21 and ending on June 20 or 21; summer usually starting from June 20 or 21 and ending on September 22 or 23; autumn usually starting from September 22 or 23 and ending on December 21 or 22; winter usually starting from December 21 or 22 and ending on March 20 or 21 of the following year. Different mouse repelling plans are performed according to the above four seasons. For example, mice are active frequently in spring and summer, and the device will increase the repelling frequency during this period and a stronger repelling means will be used. Mice tend to look for warm indoor environments in autumn and winter, and the device strengthens the indoor repelling strength during this period. Formulating different mouse repelling plans according to the four seasons can optimize resource utilization and improve the efficiency and effect of mouse repelling. In spring and summer, mice are active, so the mouse repellent plan should strengthen the intensity and frequency of repellent; in autumn and winter, the strategy may need to be adjusted to adapt to the behavior of mice seeking warm habitats due to the cold environment. This seasonal adjustment helps to reduce energy waste and reduce environmental interference, while achieving more accurate pest controlling, preventing disease transmission, and protecting human health and food safety. In addition, by collecting seasonal mouse repellent data, mouse repellent strategies can be continuously optimized to achieve smarter and more environmentally friendly mouse repellent.

In addition, in addition to targeted mouse repelling according to time and season, in the technical solution of the present application, targeted mouse repelling can also be performed according to the environment temperature and humidity. The mouse repelling device 1000 is provided with a temperature and humidity sensor 5. The temperature and humidity sensor 5 can use a high-precision sensor, such as the temperature and humidity sensor 5 with the model of DHT22 or BME280, which can used for targeted rat repelling according to the temperature and humidity changes of the environment. First, it can improve the efficiency of mouse repelling. Mice often prefer specific temperature and humidity conditions, by monitoring these conditions, the mouse repelling device 1000 can be intervened more accurately when the mouse is active. Secondly, the temperature and humidity data help the device to intelligently adjust the operating mode, such as increasing the use of ultrasonic waves or sound simulators 22 in humid environments. Thirdly, this intelligent response reduces unnecessary energy consumption, and only initiates repelling measures when needed, saving resources and reducing equipment wear. The last, adjusting the mouse repelling strategy according to temperature and humidity changes helps reduce the impact on non-target organisms and the environment.

It should be noted that the main control board 1 is provided with an artificial intelligence (AI) chip to process the time and date information of the real-time clock module 4 and the environment temperature and humidity information of the temperature and humidity sensor 5. The principle of the AI chip to carry out targeted mouse repelling in the mouse repelling device 1000 is based on data fusion and intelligent decision-making algorithm. This chip can receive and process the time and date information from the real-time clock module 4 and the environment temperature and humidity data monitored by the temperature and humidity sensor 5 in real time. Through the machine learning model or the preset logic algorithm, the AI chip analyzes these data and identifies the manners and trends of mouse activities, such as their activity level in a specific time period or environmental conditions. Then, the AI chip intelligently adjusts the mouse repelling strategy according to these analysis results, such as automatically increasing the operating frequency and intensity of the repelling module 2 at night or when the temperature and humidity are suitable for mouse activities. Furthermore, the AI chip can adjust the ultrasonic frequency, sound type and light intensity to form a variety of mouse repelling schemes. By switching different mouse repelling schemes, the most effective mouse repelling strategy can be automatically selected for different environments and mouse behavior characteristics. Ultrasonic waves and specific sounds can interfere with the auditory system of mice and affect mice' normal activities, while changing light intensity can simulate natural enemies or natural conditions and increase the insecurity of mice. Combining these factors, the AI chip can not only drive away harmful mice more humanely and reduce the impact on the environment and non-target organisms, but also improve the efficiency of mouse repelling and reduce the cost of manual intervention. In addition, the AI chip can also continuously learn and optimize, and adjust the algorithm according to the historical mouse repelling effect to achieve more accurate and effective pest controlling. This intelligent processing not only improves the efficiency of mouse repelling, but also enables the mouse repelling device1000 to adapt to various environmental conditions and realize automated and personalized pest management.

Considering that a single repelling method may have a poor effect on mouse repelling, or mice may become immune to this single repelling method over a long period of time, this solution adopts an organic combination of multiple mouse repelling methods. Specifically, the mouse repelling methods can be described as follows. The mouse repelling device 1000 adopts a sound simulator 22 to simulate miaow and a human voice. The ultrasonic generator 23 is used to emit ultrasonic waves, and a high-frequency flashlight 21 is used to perform high-frequency flashing. The multi-mode repelling method can cover a wider range of repelling frequencies and sensory stimulations, and increase the discomfort of mice, thereby improving the repelling effect. Secondly, the synergistic effect of different repelling methods can reduce the possibility of mice adapting to a single repelling signal and reduce their tolerance to specific repelling methods. Thirdly, this comprehensive repelling strategy can be flexibly adjusted according to the behavioral habits and environmental conditions of mice to achieve more accurate and effective repelling. Finally, the combined use of multiple repelling methods can provide a more comprehensive pest control solution in different environments and time periods, reducing the impact of pests on human life and health.

In one embodiment of the present application, the method for repelling the mouse further includes: recognizing, by a camera 3, that a mouse enters a predetermined space; starting the sound simulator 22 to make miaow or a human voice to frighten the mouse; and obtaining, by the camera 3, the activity trajectory of the mouse in the predetermined space; starting the high-frequency flashlight 21 to flash along an activity trajectory. In the method for repelling the mouse, the mouse repelling device 1000 first recognizes the mouse through the camera 3. The camera 3 is provided above the mouse repelling device 1000, covering the entire indoor space. The indoor space covered by the camera 3 is defined as the predetermined space. When the mouse enters the predetermined space, the camera 3 will feedback an electrical signal to the main control board 1 to control the sound module to start. The sound simulator 22 emits miaow or a human voice to drive the mouse away. The specific principle of recognizing the mouse through the camera 3 is based on computer vision and deep learning technology, especially the application of convolutional neural network (CNN). First, by setting the camera 3 in the predetermined space, the image information of all organisms in the space is captured in real time. Then, the image information is input into a pre-trained CNN model. The CNN model can learn and recognize features in images through its deep structure, thereby distinguishing different objects and modes. In this process, the CNN model is trained to specifically recognize image features of mice, such as shape, texture, and behavior modes. In this way, the system can effectively recognize and extract image information of mice from the images captured by camera 3, providing accurate target data for subsequent mouse expulsion or other automated processing. This method has high accuracy and adaptability, and can adapt to mouse recognition tasks in different environments and conditions.

It can be understood that in order to prevent the mouse from returning along the original trajectory, the camera 3 will obtain the activity trajectory of the mouse in the predetermined space and control the high-frequency flashlight 21 to start flashing along the mouse activity trajectory. The high-frequency flashlight 21 is rotatable and will cover the entire predetermined space. Image processing and mode recognition techniques are used to track the activity trajectory of mice, combined with the principle of time series analysis. First, the mouse image information captured by camera 3 is input into the image processing system, and the system uses image segmentation technology to separate the mouse from the background. Then, the key feature points of the mouse, such as the outline of the body or specific landmarks, are identified by using feature extraction technology. As time goes by, the system continuously captures images of the mouse and tracks the position changes of these feature points in consecutive frames. By analyzing the sequence data of these position changes over time, the system can calculate the running speed of the mouse and then construct the trajectory of the mouse moving in space. Through this trajectory analysis, the mouse repelling device 1000 can monitor the activity trajectory of the mouse in real time and take targeted measures, such as adjusting the operation of the repelling module 2, to improve the efficiency of mouse repelling. When the mouse returns along the activity trajectory, it will be stimulated by high-frequency flashes, so that the mouse will quickly flee, thereby preventing the mouse from returning to the nest along the original trajectory.

In order to achieve more accurate mouse repelling, the mouse repelling device 1000 can also be connected to the Internet to obtain real-time weather forecast information, and confirm the preset operating frequencies of the sound simulator 22 and the high-frequency flashlight 21 according to the weather forecast information. Through the real-time weather information, the mouse repelling device 1000 can predict and adapt to climate changes that may affect the mouse activity modes, such as temperature, humidity, rainfall, and the like, so as to adjust the mouse repelling strategy in advance. Secondly, certain weather conditions may prompt mice to look for food or shelter more frequently. According to these forecasts, the mouse repelling device 1000 can strengthen the repelling force when the mouse activity is expected to increase. Furthermore, combined with weather forecast data, the mouse repelling device 1000 can plan energy use more intelligently, such as increasing the frequency of indoor repelling when outdoor activities are reduced under severe weather conditions, so as to achieve reasonable allocation of resources. Finally, this intelligent mouse repelling method helps to improve the efficiency and adaptability of mouse repelling and reduce interference with the environment.

Furthermore, the mouse repelling device 1000 can be wall mounted or movable mounted, which will not be limited in the present application. Specifically, as shown in FIG. 1, a wall-mounted mouse repelling device is provided, which is fixed on the wall of a room, and connected to the alternating current of 220V by an external power line 6 to start operation. In another embodiment, a mobile power supply 7 is provided inside the mouse repelling device 1000, and energy is supplied by the mobile power supply 7. Four electric pulleys 8 are provided at the bottom of the mouse repelling device 1000, and the electric pulleys 8 are driven by the main control board 1 to move indoors, so that mice at some corners and dark places where mice are easy to hide can be directed to drive away, which greatly improves the practicality of the device.

The above are only some embodiments of the present application, and do not limit the scope of the present application thereto. Under the concept of this application, any equivalent structural transformation made according to the description and drawings of the present application, or direct/indirect application in other related technical fields shall fall within the claimed scope of the present application.

1. A mouse repelling device, comprising:
a main control board;
a repelling module comprising a sound simulator and a high-frequency flashlight, wherein the sound simulator is electrically connected to the main control board, and the high-frequency flashlight is electrically connected to the main control board;
a camera electrically connected to the main control board;
a real-time clock module electrically connected to the main control board; and
a temperature and humidity sensor electrically connected to the main control board.

2. The mouse repelling device according to claim 1, further comprising:
an artificial intelligence (AI) smart chip, wherein the AI chip is electrically connected to the main control board, and is configured to process data of the real-time clock module and data of the temperature and humidity sensor and control the repelling module to operate.

3. The mouse repelling device according to claim 2, wherein the repelling module further comprises an ultrasonic generator electrically connected to the main control board.

4. The mouse repelling device according to claim 1, further comprising:
a moving assembly, wherein the moving assembly is configured to drive the mouse repelling device to move.

5. A method for repelling a mouse, applied to the mouse repelling device according to claim 1 to repel the mouse, comprising:
acquiring, by the real-time clock module, current time information, and acquiring, by the temperature and humidity sensor, environment temperature and humidity information in a predetermined environment;
determining preset operating frequencies of the sound simulator and the high-frequency flashlight according to the current time information and the environment temperature and humidity information; and
controlling the sound simulator to emit miaow or a human voice and the high-frequency flashlight to flash according to the preset operating frequencies.

6. The method according to claim 5, wherein the determining preset operating frequencies of the sound simulator and the high-frequency flashlight according to the current time information and the environment temperature and humidity information comprises:
in response to that the current time information is a preset night time, controlling the sound simulator and the high-frequency flashlight to operate at a high frequency; and
in response to that the current time information is a preset day time, controlling the sound simulator and the high-frequency flashlight to operate at a low frequency.

7. The method according to claim 5, wherein the determining the preset operating frequencies of the sound simulator and the high-frequency flashlight according to the current time information and the environment temperature and humidity information further comprises:
in response to that the predetermined environment is a high temperature environment or a high humidity environment, controlling the sound simulator and the high-frequency flashlight to operate at the high frequency.

8. The method according to claim 5, further comprising:
recognizing, by a camera, that a mouse enters a predetermined space;
starting the sound simulator to make miaow or a human voice to frighten the mouse; and
starting the high-frequency flashlight to flash along an activity trajectory.

9. The method according to claim 8, wherein the obtaining the activity trajectory of the mouse in the predetermined space through the camera comprises:
obtaining, by the camera in the predetermined space, image information of all organisms in the predetermined space;
inputting obtained image information into a preset convolutional neural network (CNN) model for processing and identifying the image information of the mouse in the image information; and
obtaining the activity trajectory of the mouse based on the image information of the mouse.

10. The method according to claim 5, wherein after the controlling the sound simulator to emit miaow or the human voice and the high-frequency flashlight to flash according to the preset operating frequency, the method further comprises:
obtaining, by networking, real-time weather forecast information; and
determining preset operating frequencies of the sound simulator and the high-frequency flashlight according to the real-time weather forecast information.
